(19) United States
(12) Patent Application Publication
(10) Pub. No.: US 2008/0042823 A1
(43) Pub. Date: Feb. 21, 2008

(54) Sensor System with Acoustic Transducer

(76) Inventors: Matthew Gerald Heasley, Ware (GB); Anthony Patrick Jones, Ware (GB)

Correspondence Address: GLAXOSMITHKLINE;CORPORATE INTELLECTUAL PROPERTY, MAI B475, FIVE MOORE DR., PO BOX 13398, RESEARCH TRIANGLE PARK, NC, 27709-3398, US

(21) Appl. No.: 11/718,762

(22) PCT Filed: Nov. 9, 2005
(86) PCT No.: PCT/US05/40620

§ 371 Date: May 7, 2007

Related U.S. Application Data
(60) Provisional application No. 60/627,562, filed on Nov. 12, 2004.

(51) Int. Cl. G08B 29/02

(52) U.S. Cl. 340/506

(57) ABSTRACT

A remote sensor for determining an environmental condition within pharmaceutical packaging that is inductively powered and transmits data by acoustical telemetry. The invention further includes a power supply that can also be configured to receive data from the sensor.

### FIELD OF THE INVENTION

The present invention relates generally to devices and systems for sensing environmental conditions. More particularly, the invention relates to a sensor system and method for determining and relaying conditions in sealed pharmaceutical packaging.

### BACKGROUND OF THE INVENTION

Pharmaceutical packaging, such as sealed pockets, blister strips, disks and packs, for doses of medicaments or pharmaceutical compositions in the form of powders, tablets or capsules are well known in the art. As applied in dry powder inhaler technology, the pharmaceutical packaging (e.g., blister strips) generally comprise a base having cavities, pockets or open “blisters” adapted to receive a pharmaceutical composition (e.g., inhalable dry powder), a lid that encloses the opening of each cavity or blister, and an adhesive or bonding layer disposed therebetween to effect a seal. Further, pharmaceutical delivery devices, such as inhalers, may be prepackaged with appropriate doses of dry powder medication and ready for use.

It is further well known that pharmaceutical compositions, and in particular, inhaled dry powders, must be maintained in a hermetic environment to maintain a high degree of physical stability. Only particles having a specific narrow range of aerodynamic diameter size will deposit in the desired location in the pulmonary system. For instance, a particle for local treatment of respiratory conditions, such as asthma will have a particle size of 2-5 μm. Particle to particle agglomeration, which has been associated with moisture ingress into the pharmaceutical packaging, will tend to shift the particle size outside of this range and, hence, cause the particle(s) to deposit away from the target region of the lung.

Particle sizes, either in aerodynamic or geometric measures, referred to herein relate to a particle's effective particle size. Effective particle size denotes the apparent particle size of a body without distinction as to the number of individual particles which go to make up that body, i.e., no distinction is made between the single particle of given size and an agglomerate of the same size that is composed of finer individual particles.

Similarly, exposure of a pharmaceutical composition to high temperatures can, and in many instances will, undermine the stability and, hence, efficacy of the pharmaceutical composition. Accordingly, it is important to closely monitor the environmental conditions to which a pharmaceutical composition is exposed to ensure that the pharmaceutical composition's physical and chemical stability has not been degraded.

Determination of environmental conditions within pharmaceutical packaging is also very important for assessing the performance of the packaging material. Many pharmaceutical products are over-wrapped in aluminum foil. However, there remains a need to evaluate the effect of different over-wrapping materials on the stability of the environment in which the pharmaceutical products are held.

The most direct means for determining environmental conditions within pharmaceutical packaging is to simply puncture the material and insert a probe having the desired sensor. Naturally, this method is not particularly desirable as piercing the packaging allows the interior conditions to be modified, undermining the accuracy of the determination. Further, this destroys the packaging and prevents any ongoing monitoring of the environmental conditions.

To overcome these difficulties, attempts have been made to monitor environmental conditions within intact pharmaceutical packaging. Various remote prior art sensors have been employed. However, as discussed below, most of the noted sensors are not suitable for use “inside” pharmaceutical packaging. For example, surface acoustic wave devices, such as the humidity sensors disclosed by U.S. Pat. No. 5,739,416, require direct physical connection to the sensor. Since blister packs containing pharmaceutical compositions are sealed, any direct connection to a sensor is impractical.

On the other hand, sensors that are not disposed within the packaging do not necessarily provide an accurate indication of conditions within the interior, particularly with respect to humidity. Further, surface acoustic wave sensors are relatively expensive and, hence, not cost effective for use in commercial applications.

Fiber optic and laser telemetry sensors have also been employed to monitor environmental conditions. Illustrative is the fiber optic based moisture sensor disclosed in U.S. Pat. No. 5,319,975. However, this technology requires precise orientation of the sensor as well as direct visual communication.

Another method of remote determination of one or more environmental conditions is to monitor the induced resonant vibration of a magnetoelastic strip or sensor. A basic example of this technology is in the field of electronic article surveillance where magnetoacoustic tags are excited by a magnetic field and the corresponding mechanical resonance is then detected (see, e.g., U.S. Pat. No. 5,565,847).

An extrapolation of this technology is to monitor the acoustic or electromagnetic signal produced by a resonating magnetoelastic sensor to determine an environmental condition. For example, it is well known that the resonant frequency of a magnetoelastic material varies with temperature. It is also well known that applying a mass changing, moisture sensitive coating to a magnetoelastic material causes the resonant frequency to vary with relative humidity. Various conventional sensor systems are based in significant part on these noted principles.

By utilizing selective coatings that vary according to a desired condition or conditions, other environmental conditions can also be determined. Illustrative are the pH sensors disclosed in C. A. Grimes, A Remotely Interrogatable Magnetochemical pH Sensor, IEEE Transactions on Magnetics 33:5(1997), pp. 3412-3414. More general sensors are described U.S. Pat. No. 6,359,444. However, such devices are still complicated by the requirement of making an appropriately-sized, variably resonating article that is responsive to changes environmental conditions. For example, a 12 mm by 24 mm magnetoacoustic sensor is disclosed in Jain, et al., Magnetoacoustic Remote Query Temperature and Humidity Sensors, Smart Mater. Struc. 9(2000), pp. 502-510.

As will be appreciated by one having skill in the art, the noted sensors are too large for placement in blister packs and other conventional pharmaceutical packaging. Moreover, such sensors cannot be easily reduced in size, since size reduction substantially changes the resonant and interrogation frequencies, as well as the amplitude of the generated signal. Further, the mass changing, moisture sensitive materials disclosed by Jain et al. would yield unsatisfactory results since they would not exhibit enough mass change when employed in conjunction with a smaller sensor (i.e., magnetoelastic strip).

Thus, a significant challenge exists in incorporating a suitable sensor into the often limited space provided by existing pharmaceutical packaging. Indeed, smaller pharmaceutical packages have extremely limited internal space. Even with regard to larger articles, it is not desirable to incorporate excess volume in the packaging. Further, the packaging material itself can also significantly complicate the communication of the sensor with the exterior. For example, many attempts at using conventional radio frequency telemetry to read a sensor inside aluminized packaging have failed due to signal attenuation by the packaging.

An alternative to remote sensors having communication capabilities are conventional battery powered data loggers that simply store environmental information for later retrieval. However, data loggers are subject to various drawbacks, as well. Significantly, conventional data loggers are too large to be incorporated into many types of pharmaceutical packaging. For example, there is generally insufficient room within the over-wrap packaging of an inhaler to include a data logger. This means the data logger must be placed in the packaging without the inhaler, and thus cannot be relied upon to accurately indicate environmental conditions of the inhaler as the data logger does not travel through the standard inhaler production line. Additionally, it is not possible to monitor the conditions inside the packaging without destroying it to remove the data logger. Further, failures of the data logger are not apparent until the end of a study, which may take several months, and cannot be remedied in a timely manner. Data loggers also require a battery to operate, which presents another component that may fail before the data can retrieved and the chemistry of the battery itself can affect the environmental conditions.

It is therefore an object of the present invention to provide a highly efficient, cost effective means for determining environmental conditions within pharmaceutical packaging.

It is another object of the present invention to provide a remote sensor system and method for determining at least one, preferably, a plurality of environmental conditions within pharmaceutical packaging.

It is another object of the present invention to provide a remote sensor system and method for determining the temperature profile within pharmaceutical packaging.

It is another object of the present invention to provide a remote sensor system and method for determining the humidity profile within pharmaceutical packaging.

It is another object of the present invention to provide a remote sensor system for determining an environmental condition and a method for employing same that includes a sensor device that is adapted to measure at least one environmental condition, a power supply, power receiver and acoustic transducer.

It is another object of the present invention to provide a remote sensor system and method that can be employed with unmodified packaging.

It is another object of the present invention to provide a remote sensor system and method that is small enough to be disposed inside a pharmaceutical delivery device whereby sensed data will accurately represent environmental conditions of the packaged device.

It is another object of the present invention to provide a remote sensor system and method that can be employed on a standard packaging line to investigate standard manufacturing process.

It is another object of the present invention to provide a remote sensor system and method that can be externally powered.

It is another object of the present invention to provide a remote sensor system and method that has minimal effect on the environmental condition(s) within the packaging.

It is another object of the present invention to provide a remote sensor system and method that communicates data while maintaining the integrity of the packaging during monitoring, allowing ongoing accurate determination of environmental conditions.

It is another object of the present invention to provide a remote sensor system and method that effectively communicates data through the pharmaceutical packaging.

### SUMMARY OF THE INVENTION

In accordance with the above objects and those that will be mentioned and will become apparent below, the present invention relates to systems and methods for remotely sensing environmental conditions within pharmaceutical packaging. In one embodiment of the invention, the invention comprises a sensor capable of measuring the environmental condition, an inductive power receiver and an acoustic transducer, wherein the sensor is powered by the inductive power receiver and communicates data representing the environmental condition with the acoustic transducer. Preferably, the environmental condition comprises temperature or humidity or both. Also preferably, the apparatus is configured to be incorporated into a pharmaceutical package or incorporated into a pharmaceutical delivery device.

In another embodiment of the invention, a sensor system for determining an environmental condition is provided that comprises a remote sensor apparatus having a sensor capable of measuring the environmental condition, an inductive power receiver, an acoustic transducer, an inductive power supply having a power transmitter, a current amplifier and a signal generator. The power transmitter is configured to inductively couple with the power receiver. The sensor is powered by the inductive power receiver and communicates data representing the environmental condition with the acoustic transducer. Preferably, the inductive power supply is configured to inductively couple with the remote sensor apparatus over a distance in the range of approximately 10-20 mm.

In a preferred embodiment, the power transmitter comprises a plastic, non-conductive former having a tapered portion to produce a substantially uniform electromagnetic field having a diameter at least equal to the power receiver at a given operating distance.

In some embodiments of the invention, the inductive power supply is battery powered. Preferably, the inductive power supply is configured to operate the remote sensor apparatus without significantly affecting an environmental condition surrounding the sensor, e.g., by operating the sensor 5 times without raising the sensor temperature by more than about 1° C.

In the sensor system embodiments, the remote sensor apparatus is configured to be disposed within pharmaceutical packaging or within a pharmaceutical delivery device. In such embodiments, the sensor preferably has a volume of approximately 1300 mm³ or less.

In further aspects, the sensor system of the invention also comprises a microphone configured to receive input from the acoustic transducer. The sensor system also preferably includes a handheld reader having a data controller for receiving and interpreting output from the microphone. More preferably, the handheld reader also includes the inductive power supply.

The invention also comprises methods for determining an environmental condition within pharmaceutical packaging. In one embodiment of the invention, the method comprises the steps of sealing the remote sensor apparatus inside pharmaceutical packaging, powering the remote sensor apparatus by inductively coupling the power supply with the power receiver, measuring the environmental condition with the sensor and transmitting data corresponding to the environmental data by audio telemetry. Preferably, the method further includes the step of receiving the transmitted data by detecting the audio telemetry.

The invention also comprises a packaging assembly for determining an environmental condition within a pharmaceutical packaging, having a sensor apparatus with a sensor capable of measuring said environmental condition, an inductive power receiver and an acoustic transducer hermetically sealed within the packaging. The sensor is powered by the inductive power receiver and communicates data representing the environmental condition with the acoustic transducer. Preferably, the sensor is capable of measuring temperature or humidity or both.

In further aspects of the invention, the packaging assembly further includes a medicament or a pharmaceutical delivery device.

### BRIEF DESCRIPTION OF THE DRAWINGS

Further features and advantages will become apparent from the following and more particular description of the preferred embodiments of the invention, as illustrated in the accompanying drawing, and in which like referenced characters generally refer to the same parts or elements throughout the views, and in which:

FIG. 1 is a schematic view of a sensor system of the invention disposed within a pharmaceutical delivery device;

FIG. 2 is an elevational view of the sensor system shown in FIG. 1, illustrating the components thereof;

FIGS. 3 and 4 are elevational views of the sensor system of the invention secured to a pharmaceutical delivery device, according to the invention;

FIG. 5 is an elevational view of the primary components of a power supply of the invention;

FIG. 6 is one embodiment of a sensor system circuit diagram, according to the invention;

FIG. 7 is a top plan view of a power transmitter embodying features of the invention;

FIG. 8 is a schematic illustration of a power transmitter embodying features of the invention; and

FIG. 9 is a diagram showing the electromagnetic field produced by a power transmitter embodying features of the invention.

### DETAILED DESCRIPTION OF THE PREFERRED EMBODIMENT

Before describing the present invention in detail, it is to be understood that this invention is not limited to particularly exemplified systems or process parameters as such may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

It must be noted that, as used in this specification and the appended claims, the singular forms “a,” “an” and “the” include plural referents unless the content clearly dictates otherwise. Thus, for example, reference to “a package” includes two or more such packages.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

In describing the present invention, the following terms will be employed, and are intended to be defined as indicated below.

By the term “medicament”, as used herein, is meant to mean and include any substance (i.e., compound or composition of matter) which, when administered to an organism (human or animal) induces a desired pharmacologic and/or physiologic effect by local and/or systemic action. The term therefore encompasses substances traditionally regarded as actives, drugs and bioactive agents, as well as biopharmaceuticals (e.g., peptides, hormones, nucleic acids, gene constructs, etc.) typically employed to treat diseases and inflammatory and respiratory disorders (e.g., asthma), including, but not limited to, analgesics, e.g., codeine, dihydromorphine, ergotamine, fentanyl or morphine; anginal preparations, e.g., diltiazem; antiallergics, e.g., cromoglycate (e.g., as the sodium salt), ketotifen or nedocromil (e.g., as the sodium salt); antiinfectives e.g., cephalosporins, penicillins, streptomycin, sulphonamides, tetracyclines and pentamidine; antihistamines, e.g., methapyrilene; anti-inflammatories, e.g., beclomethasone (e.g., as the dipropionate ester), fluticasone (e.g., as the propionate ester), flunisolide, budesonide, rofleponide, mometasone (e.g., as the furoate ester), ciclesonide, triamcinolone (e.g., as the acetonide), 6α,9α-difluoro-11β-hydroxy-16α-methyl-3-oxo-17α-propionyloxy-androsta-1,4-diene-17β-carbothioic acid S-(2-oxo-tetrahydro-furan-3-yl) ester or 6α,9α-difluoro-17α-[(2-furanylcarbonyl)oxy]-11β-hydroxy-16α-methyl-3-oxoandrosta-1,4-diene-17β-carbothioic acid S-fluoromethyl ester; antitussives, e.g., noscapine; bronchodilators, e.g., albuterol (e.g., as free base or sulphate), salmeterol (e.g., as xinafoate), ephedrine, adrenaline, fenoterol (e.g., as hydrobromide), formoterol (e.g., as fumarate), isoprenaline, metaproterenol, phenylephrine, phenylpropanolamine, pirbuterol (e.g., as acetate), reproterol (e.g., as hydrochloride), rimiterol, terbutaline (e.g., as sulphate), isoetharine, tulobuterol or 4-hydroxy-7-[2-[[2-[[3-(2-henylethoxy)propyl]sulfonyl]ethyl]amino]ethyl-2(3H)-benzothiazolone; PDE4 inhibitors e.g. cilomilast or roflumilast; leukotriene antagonists e.g. montelukast, pranlukast and zafirlukast; adenosine 2a agonists, e.g., (2R,3R,4S,5R)-2-[6-Amino-2-(1S-hydroxymethyl-2-phenyl-ethylamino)-purin-9-yl]-5-(2-ethyl-2H-tetrazol-5-yl)- tetrahydro-furan-3,4-diol (e.g., as maleate); α₄ integrin inhibitors, e.g., (2S)-3-[4-({[4-(aminocarbonyl)-1-piperidinyl]carbonyl}oxy)phenyl]-2-[((2S)-4-methyl-2-{[2-(2-methylphenoxy)acetyl]amino}pentanoyl)amino]propanoic acid (e.g., as free acid or potassium salt)], diuretics, e.g., amiloride; anticholinergics, e.g., ipratropium (e.g., as bromide), tiotropium, atropine or oxitropium; ganglionic stimulants, e.g., nicotine; hormones, e.g., cortisone, hydrocortisone or prednisolone; xanthines, e.g., aminophylline, choline theophyllinate, lysine theophyllinate or theophylline; therapeutic proteins and peptides, e.g., insulin or glucagon; vaccines, diagnostics, and gene therapies. The noted medicaments may be employed in the form of salts, (e.g., as alkali metal or amine salts or as acid addition salts) or as esters (e.g., lower alkyl esters) or as solvates (e.g., hydrates) to optimize the activity and/or stability of the medicament.

The term “medicament” specifically includes albuterol, salmeterol, fluticasone propionate and beclomethasone dipropionate and salts or solvates thereof, e.g., the sulphate of albuterol and the xinafoate of salmeterol.

The term “medicament” further includes formulations containing combinations of active ingredients, including, but not limited to, salbutamol (e.g., as the free base or the sulfate salt) or salmeterol (e.g., as the xinafoate salt) or formoterol (e.g., as the fumarate salt) in combination with an anti-inflammatory steroid such as a beclomethasone ester (e.g., the dipropionate), a fluticasone ester (e.g., the propionate), a furoate ester or budesonide.

By the terms “medicament formulation” and “pharmaceutical composition”, as used herein, it is meant to mean a combination of at least one medicament and one or more added components or elements, such as an “excipient” or “carrier.” As will be appreciated by one having ordinary skill in the art, the terms “excipient” and “carrier” generally refer to substantially inert materials that are nontoxic and do not interact with other components of the composition in a deleterious manner. Examples of normally employed “excipients,” include pharmaceutical grades of carbohydrates, including monosaccharides, disaccharides, cyclodextrins and polysaccharides (e.g., dextrose, sucrose, lactose, raffinose, mannitol, sorbitol, inositol, dextrins and maltodextrins); starch; cellulose; salts (e.g., sodium or calcium phosphates, calcium sulfate, magnesium sulfate); citric acid; tartaric acid; glycine; leucine; high molecular weight polyethylene glyols (PEG); pluronics; surfactants; lubricants; stearates and their salts or esters (e.g., magnesium stearate); amino acids; fatty acids; and combinations thereof.

The noted medicaments and excipients may be prepared as composite materials, such as by co-precipitation or by coating, or other method known in the art, or may be prepared from batches of separately prepared individual particles which are subsequently blended together to form particulate mixtures of medicament and excipient particles.

By the term “pharmaceutical delivery device”, as used herein, it is meant to mean a device that is adapted to administer a controlled amount of a composition to a patient, including, but not limited to, the Diskus® device disclosed in U.S. Pat. Nos. Des. 342,994, 5,590,654, 5,860,419, 5,837,630 and 6,032,666. The term “pharmaceutical delivery device” further includes the Diskhaler™ device disclosed in U.S. Pat. Nos. Des 299,066; 4,627,432 and 4,811,731; the Rotahaler™ device disclosed in U.S. Pat. No. 4,778,054; the Cyclohaler™ device by Norvartis; the Turbohaler™ device by Astra Zeneca; the Twisthaler™ device by Schering Plough; the Handihaler™ device by Boehringer Ingelheim; the Airmax™ device by Baker-Norton; and the Dura and Inhaled Therapeutic active delivery systems. Each of the noted “pharmaceutical delivery devices” are incorporated by reference herein.

By the terms “pharmaceutical packaging” and “packaging”, as used herein, it is meant to mean conventional pharmaceutical containment systems and packaging having at least one sealable pocket, cavity or blister adapted to contain at least one medicament or a pharmaceutical composition in any conventional form, including a powder, capsule or tablet. The terms “pharmaceutical packaging” and “packaging” thus include conventional blister strips, disks (e.g., Rotadisk™), packs, sheets and individual containers that are employed in the aforementioned “pharmaceutical delivery devices”, including, but not limited to, the pharmaceutical packaging disclosed in U.S. Pat. Nos. 6,032,666, 6,155,423 and 4,778,054.

As will be appreciated by one having ordinary skill in the art, the present invention substantially reduces or eliminates the disadvantages and drawbacks associated with conventional sensor systems and methods for monitoring environmental conditions. As indicated, the sensors of the invention are configured to wirelessly receive power to measure environmental conditions, such as temperature and humidity, and then wirelessly transmit data through the pharmaceutical packaging representing the environmental conditions. Thus, the inventive sensors and methods allow measurements to be made without interfering with the integrity of the packaging, are small enough to be incorporated within the pharmaceutical packaging or delivery device packaging, do not rely on batteries that may fail or effect environmental conditions and allow ongoing monitoring of environmental conditions.

In a preferred embodiment of the invention, an inductive coupling is used to power a temperature and humidity sensor and associated electronics inside the pharmaceutical packaging without the need for connecting wires or batteries. The inductive coupling is optimized for the medicament or pharmaceutical composition, pharmaceutical delivery device and packaging characteristics. The sensor is powered inductively and transmits data acoustically to maintain the packaging integrity and avoids alteration of the packaging. The acoustic data transmission also minimizes signal interference.

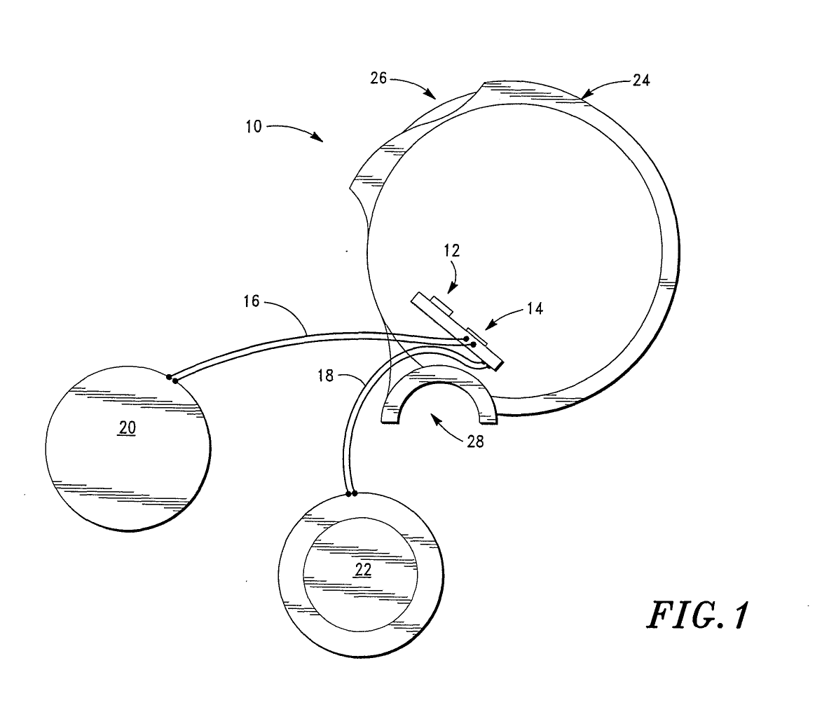

Referring now to FIG. 1, there is shown a pharmaceutical delivery device 10 having sensor 12 and controller 14 mounted inside device 10, according to the invention. Wires 16 and 18 provide connection to inductive power receiver 20 and acoustic transducer 22. Device 10 generally comprises housing 24 that is configured to have mouth piece 26 and thumb hold 28 to facilitate inhalation of a desired medicament. Details of the delivery device 10 are set forth in U.S. Pat. Nos.5,590,645, 5,860,419, 5,873,360, 6,032,666, 6,378,519 and 6,536,427, which are incorporated by reference herein in their entirety.

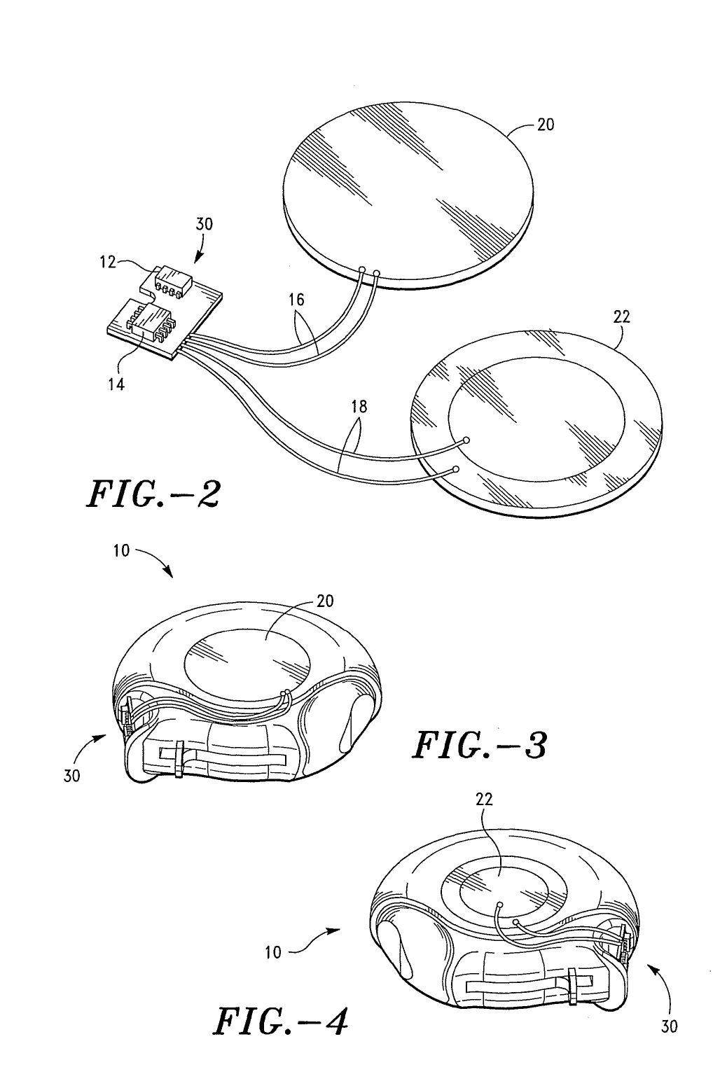

Referring now to FIG. 2, there is shown the components of the sensor system. As illustrated in FIG. 2, the system includes a power receiver 20 and acoustic transducer 22 that is connected to printed circuit board (PCB) 30 having sensor 12 and controller 14 disposed thereon. As illustrated in FIGS. 3 and 4, power receiver 20 and acoustic transducer 22 preferably comprise thin, flat members that can be applied to the exterior sides of device 10 without interfering with standard over-wrap packaging.

Alternatively, as illustrated in FIG. 1, PCB 30 is disposed inside the pharmaceutical delivery device 10, even with a full blister strip, with wires 16 and 18 extending through the housing 24 to the power receiver 20 and acoustic transducer 22. Power receiver 20 and acoustic transducer 22 may also be disposed inside the pharmaceutical delivery device 10. Inductive power supply 32, as shown in elevational view in FIG. 5, is configured to be inductively coupled to power receiver 20 to allow operation of sensor 12, controller 14 and acoustic transducer 22.

Referring to FIG. 5, power supply 32 generally comprises power source 34, switch 36, signal generator 38, current amplifier 40 and power transmitter 42. In this embodiment, the sensor 12 and controller 14 are preferably approximately 20×13×5 mm³ (1300 mm³) in size, which allows inclusion of the sensor 12 and controller 14 within device 10.

Referring now to FIG. 6, there is shown a circuit diagram reflecting a preferred circuit for the sensor system of the invention, wherein line 44 schematically represents the portion of the circuit contained within the pharmaceutical packaging. A description of the preferred electronic components identified in FIG. 6 is set forth in Table I.

TABLE I

| Code | Device | Description |
|---|---|---|
| U1 | 5 v regulator | At least 100 mA and less than 0.5 V |
| | | dropout |
| U2 | Microcontroller | PIC12F629 |
| U3 | 3 v regulator | MC78LC30NTR. |
| U4 | Reset chip | ZXCM209RF, 2.63 v. |
| U5 | Microcontroller | PIC12C672-04I/SM. |
| U6 | Sensor | Sensirion SHT15. |
| X1 | Resonator | Ceramic Resonator specified to |
| | | 4.00 MHz. |
| T1 | MOSFET | IRL2910. V_{DSS} ≧ 90 v, controllable |
| | | with logic levels. |
| D1 | LED | Shows the coil is activated. |
| D2a/b | 2 Schottky Diodes | BAT721S. |
| D3a/b | 2 Schottky Diodes | BAT721S. |
| D4 | 8v2 Zener Diode | BZX284C8V2. V_{IN(U3)MAX} = 10 v. |
| L1 | Power transmission | 53 μH. |
| | coil | |
| L2 | Power receiving | 79 μH. |
| | coil | |
| C1 | Tank capacitor | 1000 μF, 10 v. |
| C2 | Tuning capacitor | 68 nF, 100 v. |
| C3 | Tuning capacitor | 68 nF, 100 v. |
| C4 | Tuning capacitor | 330 nF, 10 v. |
| C5 | Smoothing | 1 μF, 10 v. |
| | capacitor | |
| C6 | Regulator | 220 nF, 25 v (>3 v required) |
| | stabilizer | |
| R1 | Current limiting | 220Ω. |
| R2 | Pull-down resistor | 4.7 kΩ., e.g. should be >1 kΩ. |
| R3 | Pull-up resistor | 10 kΩ., e.g., should be >1 kΩ, |
| | | but <100 kΩ. |
| R4 | Current limiting | 1.5 kΩ. |
| BAT1 | Power source | 2 × 3 v lithium batteries. |
| S1 | Push switch | Momentary. |
| LS1 | Acoustic | Piezo ceramic transducer, 35 mm |
| | transducer | diameter. Maplin code YU85G. |
| LS2 | Microphone | Input into computer or handheld |
| | | reader device. |

Referring to FIG. 6, U1 comprises a voltage regulator that preferably has a dropout voltage of less than 0.5v with a current supply capability of at least 100mA. U2 comprises a microcontroller that is preferably readily reprogrammable and small in size. U3 comprises another voltage regulator that preferably has a very low dropout voltage and quiscent current to allow operation with maximum separation of coils L1 and L2. U4 comprises a reset chip that is adapted to prevent the microcontroller from running when the voltage is too low for the sensor to operate, thus preventing anomalous results. U5 comprises a microcontroller that preferably has a small form factor while still having a relatively large ROM. U6 comprises the sensor of the invention, which is capable of measuring the desired environmental conditions, such temperature and humidity. The sensor preferably has low power requirements, is small in size and maintains high accuracy.

T1 comprises a Metal Oxide Semiconductor Field Effect Transistor (MOSFET) and exhibits V_{DSS}≧90v, very fast switching to reduce power wastage during switching, very low R_{DS(on)} to reduce power wastage and heating when switched on in the FET, and is controllable with logic levels. D2a/b and D3a/b preferably have extremely low V_{F} and high V_{R} to allow reliable operation with maximum coil separation. Zener diode D4 is preferably adapted to prevent possible overload of U3 when coil separation is small, for example V_{IN(U3)MAX}=10v.

L1 and L2 comprise power transmitter 42 and power receiver 20. The design parameters of these components are discussed in greater detail below.

C1 comprises a reservoir capacitor that smoothes the supply and protects the battery BAT1 from reverse currents. C2, C3 and L1 comprise a resonant circuit. According to the invention, when T1 is switched off, current oscillates in C2, C3 and L1 at the resonant frequency of the circuit.

The resonant frequency of C4 and L2 is arranged to be the same or approximately the same as the resonant frequency of C2, C3 and L1 in order to maximize power transfer between L1 and L2. C5 comprises a smoothing capacitor to condition the power supply voltage. C5 similarly preferably prevents overloading of U3 when L1 and L2 are very close together.

R4 comprises a current limiting resistor that limits the acoustic output to the minimum level consistent with reliable data communications and also reduces overall power requirements. BAT1 comprises power source 34.

Preferably, battery type CR123A has sufficiently high capacity and is relatively inexpensive. LS1 comprises acoustic transducer 22 that preferably exhibits minimal thickness while maintaining adequate output volume. In this embodiment, the circular configuration allows the acoustic transducer to be positioned on the side of device 10, as shown in FIG. 4, without interfering with the pharmaceutical packaging over-wrap. LS2 comprises a microphone that is configured to receive the output from acoustic transducer 22, and provides input into a PC or handheld reader 50.

In this embodiment, sensor 12 preferably comprises a Sensirion SHTx5 temperature and relative humidity sensor. The sensor has a small size (≈7.5×5×2.5 mm³), high accuracy (±2% RH, ±0.4° C.) and provides a relatively simple interface with controller 14 through serial and data lines, as all measurements are digitized by the sensor.

To avoid affecting relative humidity measurements, the heat producing components should not be disposed near the sensor. As such, U3 is located as far from sensor 12 as possible, copper under the sensor should be minimized since it is a good conductor of heat, and slots should be cut in the PCB around the sensor to minimize heat conduction from the main circuit.

Since a PTFE based PCB has a much lower moisture absorption than standard (for example FR4) material, PCB 30 is preferably constructed out of PTFE to reduce the moisture absorbency of the device. According to the invention, a 0.8 mm thick PCB board can be employed.

Controller U5 can comprise a PIC12C672-04I/SM, which is available from Arizona Microchip, or a suitable alternative. U5 of each sensor device can also be programmed to have a unique serial number that may be transmitted with each sensor reading.

Inductive power supplies are commonly used to supply power to an electrical circuit without connecting wires. However, power supplies suitable for the practice of the invention have certain characteristics. Depending upon the embodiment and the type of pharmaceutical packaging, separation between power receiver 20 and power transmitter 42 can be up to approximately 12 mm. The power supply must be robust enough to transmit across this distance and through the pharmaceutical packaging material, which may be metallic. Further, the power supply must be efficient, as too much heat generation will affect the sensor readings. Preferably, the power supply should allow at least 5 readings to be made sequentially without raising the temperature of the sensor by more than about 1° C.

Also, the systems and methods of the invention should be useful in environments having high humidity, which would make a wired, AC powered device undesirable from a safety perspective. The power supply should also be useful in mobile applications and preferably incorporate a handheld reader device. Such a device would provide power to the sensor, receive and decode the data, and either store the data or relay the data back to a computer.

Finally, power transmitter 42 should be configured to allow easy coupling with power receiver 20 within the pharmaceutical packaging. For example, the induced magnetic field should be approximately even in 20 mm diameter circles parallel to the face of transmitter 42 to allow easy location of device 10 relative to the transmitter. Accordingly, a preferred embodiment of the power supply is a low voltage, battery powered wireless and mobile device.

Power supply 32 generally has three separate functions. The functions include power transmission, current amplification and signal generation.

Referring now to FIGS. 7 and 8, power transmitter 42 comprises lightweight plastic former 46 and coil 48, wound using approximately 30 turns of tightly-wound, approximately 1.12 mm diameter, enameled covered copper wire. As illustrated in FIG. 7, coil 48 is preferably formed over a constant diameter portion of about 2.5 mm thickness and a tapered portion of about 5 mm thickness of plastic former 46. In the top view, shown in FIG. 8, the tapered portion of former 46 ranges from a radius of about 15 mm to about 25 mm.

It has been found that using relatively thick wire and a low number of turns minimizes the resistance of the coil. In this embodiment resistance is preferably approximately 80 mΩ. As will be appreciated by one having ordinary skill in the art, inductance depends on coil geometry, wire geometry and materials used.

The use of a non-conductive, non-magnetic plastic former rather than, for example, an iron core is a major factor in keeping the inductance down. The use of a relatively large diameter also has this effect to some extent while keeping the field relatively even.

In this embodiment, a relatively low number of turns results in an inductance of approximately 53 μH. Increasing the current flowing through the inductor increases the strength of the magnetic field, but as long as the resistance is low, power wastage can be minimized despite the large currents involved.

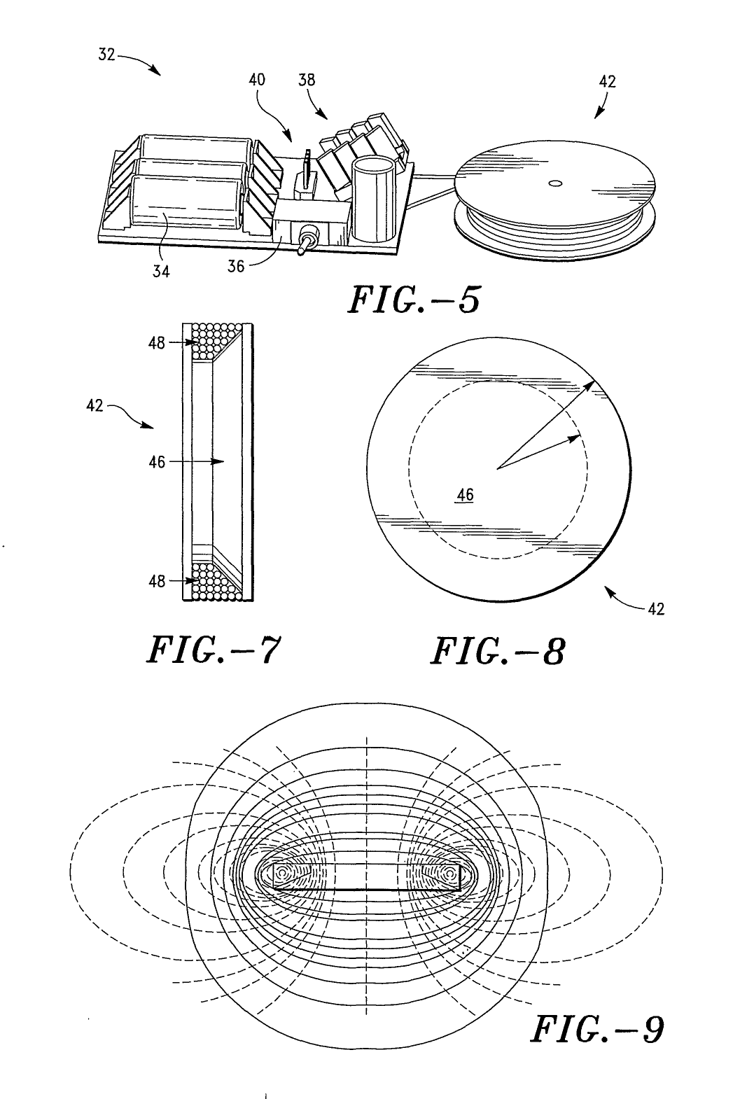

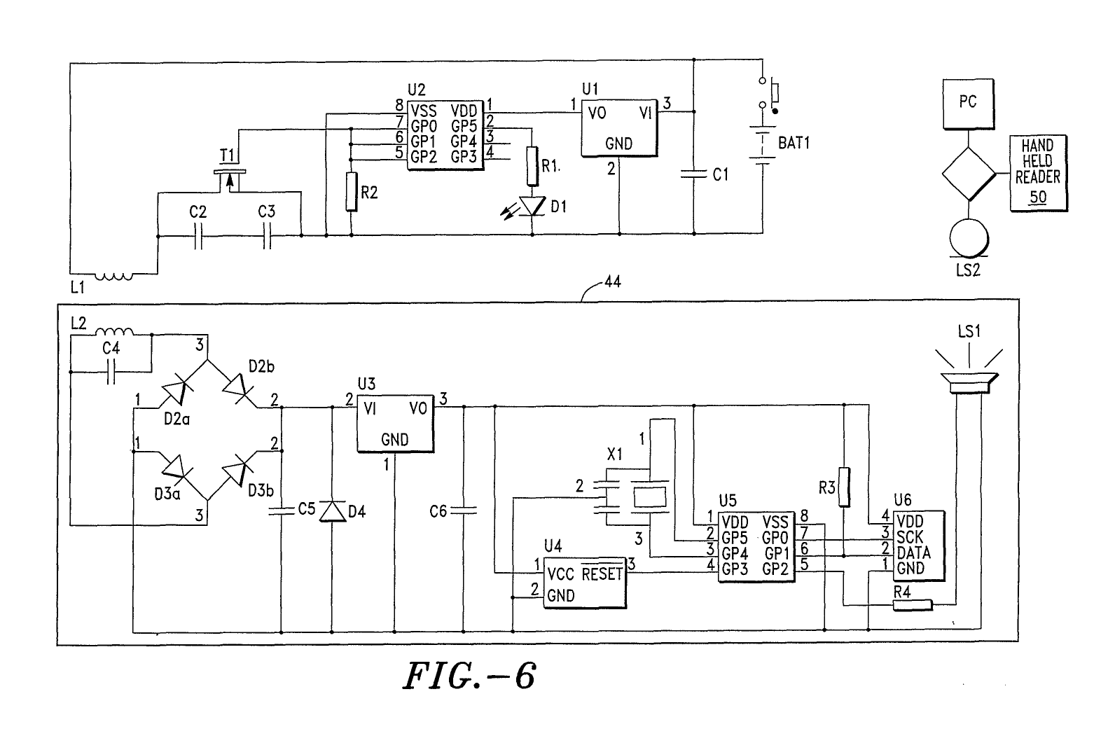

Referring now to FIG. 9, there is shown a diagram of the preferred magnetic field generated by power transmitter 42. From the areas showing strong magnetic field in the diagram, one having skill in the art will appreciate that at an operating distance of approximately 10 mm from the coil, the field is even over a 30 mm diameter circle and at a distance of 15 mm from the coil, the field is even over a 20 mm diameter circle. This permits an easy interface with power receiver 20 of device 10. The diagram also illustrates that the magnetic field is stronger above the power transmitter than below it and is very even. This indicates that the power transfer efficiency is very high.

As discussed above, current amplification for power transmitter 42 is preferably driven by the circuit shown in FIG. 6. Design goals for suitable circuits include (i) low input voltage, such as up to 12V to allow convenient battery power, (ii) high efficiency to reduce heating and reduce frequency of battery replacement, (iii) circuit design for easy construction and long-term reliability, and (iv) maximizing AC current through the inductor to maximize the magnetic field. Further, to minimize the chance of affecting sensor 12, the components of power supply 32 that generate heat should be kept as far from power transmitter 42 as possible. Specifically, power supply 32 should be designed to position BAT1, U1, T1 and C1, C2 and C3 at a distance from transmitter 42.

In a preferred embodiment, the signal generator has a square-wave input to T1 at a desired transmission frequency, such as 30 kHz. A PIC12F629 microcontroller from Arizona Microchip, using an internal oscillator and appropriate firmware is thus suitable.

As illustrated in FIG. 6, three of the microcontroller output lines are preferably connected together to the input of T1, since the load is very capacitive. The input to T1 is also connected to ground by a relatively large value resistor, such as 4.7 kΩ, such that the connection does not float high when the microcontroller first starts up. This set-up leaves 3 pins available, which could be used to add control or data interfaces if required.

One having skill in the art will recognize that the functions performed by this microcontroller could be implemented in a variety of other devices. In embodiments comprising a handheld device, a more powerful microcontroller capable of receiving and displaying data from the sensor is preferred. Further, a microcontroller equipped with an analog to digital converter that can measure battery voltage when the power transmitter is in use would provide feedback on battery charge level.

Power receiver 20 preferably comprises a flat, printed circuit board based coil of about 79 μH and about 4 cm diameter. This embodiment comprises a copper spiral with 39 turns on each side of the circuit board, which should run in the same orientation. This configuration allows easy placement on the side of device 10, as shown in FIG. 3, and facilitates placement of device 10 relative to power supply 42. Moreover, this configuration reduces requirements of the power supply as power receiver 20 is relatively wider to couple with more of the magnetic field and can be positioned closer to power transmitter 42. In this embodiment, power source 34 can be 6v, as described above. Preferably, the printed circuit board of power receiver 20 is made using PTFE to minimize moisture absorbency. According to the invention, the thickness of the power receiver PCB can be 0.4 mm or 0.8 mm as desired.

Communication of data collected from sensor 12 is accomplished by acoustic transducer 22. As is well know, audio encoded telemetry is commonly used in telecommunications, e.g., MODEMs for computer communications. Accordingly, this invention employs acoustic transmission to overcome the electrical shielding characteristics of the metallic pharmaceutical packaging. Indeed, sound waves are relatively unaffected by the pharmaceutical packaging, and thus provide a significant advantage over radio frequency transmission.

In preferred embodiments of the invention, audio waves below about 2 kHz are the preferred means of transmitting data from sensor 12. More preferably, the data is sent using the conventional RTTY protocol, although any type of audio telemetry is suitable. As is well known, RTTY utilizes Frequency-Shift-Keying (FSK), allowing for easy detection of the signal over random noise.

In embodiments where acoustic data is processed by a personal computer, existing telemetry or telecommunications software methods can be adapted to interpret the signal. Alternatively, a handheld reader can be employed that includes power supply 32 and a microphone (as shown in FIG. 6) that feeds input into a data controller programmed to interpret the encoded data and then display, store or relay that data.

In preferred embodiments, a curve fitting algorithm for the environmental condition being monitored by a given sensor is optimized to improve the quality of the data. As such, it may be desirable for controller 14 to comprise a device such as the PIC12C672, which has a relatively large amount of ROM. In embodiments not requiring significant algorithm optimization, controller 14 may require less ROM and can comprise a device such as PIC12F629.

In one embodiment, Baudot code can be used and the data transmitted twice at 150 baud for every measurement taken from the sensor. An example format suitable in the practice of the invention is shown in Table II. High frequency is approximately 1300 Hz and low frequency is approximately 1130 Hz.

TABLE II
Data Transmission Format

Signal to stabilize receiver
Carriage Return
S
5 figure serial number in decimal
Space
H
Humidity in form xx.xx
Space
T
Temperature in form −xx.xx if negative or xxx.xx if positive
3 spaces
S
5 figure serial number in decimal
Space
H
Humidity in form xx.xx
Space
T
Temperature in form −xx.xx if negative or xxx.xx if positive
3 spaces

As one having skill in the art will recognize, the sensor systems and methods of the invention work with unmodified packaging, are small enough to be fitted in pharmaceutical delivery devices, do not require internal batteries, and communicate ongoing data regarding environmental conditions through pharmaceutical packaging. Indeed, since the sensor system is powered inductively, accurate determination of environmental conditions within the pharmaceutical packaging can be made indefinitely. This allows one to determine the effectiveness of the pharmaceutical packaging over any given period of time, such as days, weeks, months or years and the environmental condition can be monitored at any point over that period of time.

Without departing from the spirit and scope of this invention, one of ordinary skill can make various changes and modifications to the invention to adapt it to various usages and conditions. In particular, the invention has been described primarily in reference to the determination of temperature and humidity within pharmaceutical packaging. However, the invention may be applied to remotely determine any suitable environmental condition within any package, container or other enclosed space. As such, these changes and modifications are properly, equitably, and intended to be, within the full range of equivalence of the following claims.

What is claimed is:

1. A sensor apparatus for determining an environmental condition, comprising:
a sensor capable of measuring said environmental condition;
an inductive power receiver; and
an acoustic transducer,
wherein said sensor is powered by said inductive power receiver and communicates data representing said environmental condition with said acoustic transducer.

2. The sensor apparatus of claim 1, further comprising a controller that is adapted to operate said sensor, said power receiver and said acoustic transducer.

3. The sensor apparatus of claim 1, wherein said environmental condition comprises temperature.

4. The sensor apparatus of claim 1, wherein said environmental condition comprises humidity.

5. The sensor apparatus of claim 1, wherein said sensor is responsive to a second environmental condition.

6. The sensor apparatus of claim 5, wherein said sensor is responsive to temperature and humidity.

7. The sensor apparatus of claim 1, wherein said apparatus is configured to be incorporated into a pharmaceutical package.

8. The sensor apparatus of claim 1, wherein said apparatus is configured to be incorporated into a pharmaceutical delivery device.

9. A sensor system for determining an environmental condition, comprising
a remote sensor apparatus having a sensor capable of measuring said environmental condition, an inductive power receiver, and an acoustic transducer; and
an inductive power supply having a power transmitter, a current amplifier and a signal generator,
wherein said power transmitter is configured to inductively couple with said power receiver and wherein said sensor is powered by said inductive power receiver and communicates data representing said environmental condition with said acoustic transducer.

10. The sensor system of claim 9, wherein said inductive power supply is configured to inductively couple with said remote sensor apparatus over a distance of about 20 mm.

11. The sensor system of claim 10, wherein said inductive power supply is configured to inductively couple with said remote sensor apparatus over a distance of about 15 mm.

12. The sensor system of claim 9, wherein said power transmitter comprises a non-conductive former.

13. The sensor system of claim 12, wherein said former includes a constant diameter portion and a tapered portion.

14. The sensor system of claim 13, wherein said inductive power supply is configured to produce a substantially uniform electromagnetic field having a diameter at least equal to said power receiver at a first operating distance.

15. The sensor system of claim 9, wherein said inductive power supply is battery powered.

16. The sensor system of claim 9, wherein said inductive power supply is configured to operate said remote sensor apparatus without significantly affecting an environmental condition surrounding said sensor.

17. The sensor system of claim 16, wherein said environmental condition comprises temperature and wherein said inductive power supply is configured to operate said remote sensor apparatus at least about 5 times sequentially without raising said temperature more than about 1° C.

18. The sensor system of claim 9, wherein said remote sensor apparatus is configured to be disposed within pharmaceutical packaging.

19. The sensor system of claim 18, wherein at least a portion of said remote sensor apparatus is configured to be disposed within a pharmaceutical delivery device.

20. The sensor system of claim 19, wherein said sensor has a volume about 1300 mm³ or less.

21. The sensor system of claim 20, further comprising a microphone configured to receive input from said acoustic transducer.

22. The sensor system of claim 21, wherein said microphone outputs to a data controller configured to decode output from said acoustic transducer.

23. The sensor system of claim 22, wherein said microphone and data controller are integrated into a handheld reader.

24. The sensor system of claim 23, wherein said handheld reader further includes said inductive power supply.

25. A method for determining an environmental condition within pharmaceutical packaging, said method comprising the steps of:
sealing a remote sensor apparatus inside said pharmaceutical packaging, said remote sensor apparatus having a sensor capable of measuring said environmental condition and an inductive power receiver;
inductively powering said remote sensor apparatus;
measuring said environmental condition with said sensor; and
transmitting data corresponding to said environmental data by audio telemetry.

26. The method of claim 25, further comprising the step of receiving said transmitted data by detecting said audio telemetry.

27. The method of claim 25, wherein said step of transmitting data comprises transmitting sound waves have a frequency of less than about 2000 Hz.

28. The method of claim 25, wherein said step of inductively powering said remote sensor apparatus comprises powering said remote sensor apparatus without significantly altering said environmental condition.

29. The method of claim 25, wherein said step of measuring said environmental condition comprises measuring humidity.

30. The method of claim 25, further comprising the step of measuring an additional environmental condition wherein said remote sensor apparatus is capable of measuring said additional environmental condition.

31. The method of claim 30, comprising measuring temperature and humidity.

32. The method of claim 25, wherein said steps do not alter said pharmaceutical packaging.

33. The method of claim 26, wherein said steps of inductively powering and receiving are effectuated with a mobile, handheld reader that comprises an inductive power supply and a microphone.

34. The method of claim 25, wherein the steps of measuring and transmitting occur a plurality of times over a given time period.

35. The method of claim 25, wherein the step of sealing said remote sensor apparatus inside said pharmaceutical packaging does not alter said pharmaceutical packaging.

36. A packaging assembly for determining an environmental condition within pharmaceutical packaging, comprising:
a sensor apparatus having a sensor capable of measuring said environmental condition;
an inductive power receiver; and
an acoustic transducer hermetically sealed within said packaging, wherein said sensor is powered by said inductive power receiver and communicates data representing said environmental condition with said acoustic transducer.

37. The packaging assembly of claim 36, wherein said sensor is capable of measuring humidity.

38. The packaging assembly of claim 36, wherein said sensor is capable of measuring temperature.

39. The packaging assembly of claim 36, wherein said sensor element is capable of measuring temperature and humidity.

40. The packaging assembly of claim 36, wherein said pharmaceutical packaging further contains a medicament.

41. The packaging assembly of claim 36, wherein said pharmaceutical packaging further contains a pharmaceutical delivery device.

42. The packaging assembly of claim 40, wherein said medicament is selected from the group consisting of albuterol, salmeterol, fluticasone propionate, beclomethasone dipropionate and salts, solvates and combinations thereof.

43. A method for determining an environmental condition within pharmaceutical packaging, said method comprising the steps of:
sealing a remote sensor apparatus inside said pharmaceutical packaging, said remote sensor apparatus having a sensor capable of measuring said environmental condition and an inductive power receiver;
powering said remote sensor apparatus by inductively coupling a power supply having a power transmitter, a current amplifier and a signal generator with said power receiver;
measuring said environmental condition with said sensor; and
transmitting data corresponding to said environmental data by audio telemetry.
